(19) United States
(12) Patent Application Publication
(10) Pub. No.: US 2007/0018443 A1
(43) Pub. Date: Jan. 25, 2007

(54) Off-road wheelchair

(76) Inventor: John Wilmot, Milton-Freewater, OR (US)

Correspondence Address: Floyd E. Ivey;Liebler, Ivey, Connor & Berry, P.O. Box 6125, Kennewick, WA, 99336, US

(21) Appl. No.: 11/185,583

(22) Filed: Jul. 19, 2005

(51) Int. Cl. B62D 49/08; B62H 7/00

(52) U.S. Cl. 280/755; 280/293; 280/304.1

(57) ABSTRACT

An improved wheelchair frame and wheel with a stabilizing wheel frame (300) supporting a stabilizing wheel (320) having a protruding stabilizing wheel ridge (330). The stabilizing wheel frame (300) affixes to a front frame transverse member (380) which rotates about a transverse pivot (385). The rotation of the front frame transverse member (380) is dampened by attachment to a shock absorber (390) which is anchored to a shock absorber anchor (395). Additional stabilization is afforded by a rear stabilizing wheel frame (400) which supports at least one stabilizing wheel (320) at the rear (7) which may have a rear stabilizing wheel ridge (330).

### FIELD OF THE INVENTION

The invention is an improvement in the ability to navigate a wheelchair in rough terrain.

### BACKGROUND OF THE INVENTION

The operator of a wheelchair will encounter many obstacles to smooth movement. The operation of a standard wheelchair on other that a smooth and hard surface is problematic. Uneven surfaces, pebbles and rocks can inhibit movement. Soft surfaces can trap wheels causing the wheelchair to become stuck.

### SUMMARY OF THE INVENTION

This invention comprises a stabilizing wheel frame (300) supporting a stabilizing wheel (320) having a protruding stabilizing wheel ridge (330). The stabilizing wheel frame (300) affixes to a front frame transverse member (380) which rotates about a transverse pivot (385). The rotation of the front frame transverse member (380) is dampened by attachment to a shock absorber (390) which is anchored to a shock absorber anchor (395). Additional stabilization is afforded by a rear stabilizing wheel frame (400) which supports at least one stabilizing wheel (320) which may have a rear stabilizing wheel ridge (330).

### BRIEF DESCRIPTION OF THE DRAWINGS

FIG. 1 illustrates a wheelchair (1) with standard configuration for smooth surface travel having a chair frame (100) and a main frame (200).

FIG. 2 illustrates a wheelchair (1) having a front (3), a rear (7), a right side (8) and a left side (9); a main frame (200); a stabilizing wheel frame (300) with stabilizing frame (340) having a first end (342) and a second end (344); a stabilizing wheel (320) rotatably received at the first end (342); the stabilizing wheel frame (300) fixedly received by the wheelchair (1) main frame (200) at the second end (344).

FIG. 3 is a cut away from FIG. 2 illustrating a partial view of the chair frame (100) and showing the main frame (200) composed of frame means; a stabilizing wheel frame (300), at least one front stabilizing frame (340) having a first end (342) and a second end (344); a stabilizing wheel (320) rotatably received at the first end (342); the stabilizing wheel frame (300) fixedly received by the wheelchair (1) main frame (200) at the second end (344); the stabilizing wheel frame (300) extending outwardly from the wheel chair front (3); at least one main frame transverse member (220); at least one front frame extension (360); at least one transverse pivot (385); shock absorber means (390) with shock absorber first end (391), shock absorber second end (393), shock absorber anchor (395), shock absorber pivot (392) and shock absorber front member (394); front frame transverse member (380). Also seen is rear main frame transverse member (240) at the rear (7), primary main frame members (210), rear stabilizing wheel frame (400) and stabilizing wheel (320) having a wheel axle and bearing means (500) with a stabilizing wheel ridge (330).

FIG. 4 is a cutaway from FIG. 3 showing features of FIG. 3 absent the chair frame (100).

FIG. 5 is a detail from FIG. 4 illustrating the stabilizing wheel frame (300); front stabilizing frame (340), first end (342), second end (344), main frame member (210), main frame transverse member (220), front frame extension (360), transverse pivot (385). Also seen is shock absorber means (390), shock absorber first end (391), shock absorber second end (393), shock absorber anchor (395); shock absorber pivot (392), shock absorber front member (394) and front frame transverse member (380).

FIGS. 6 and 6A are sections from FIG. 4 illustrating the stabilizing wheel (320) as ellipsoidal, spheroidal, or spherical having a major axis (440) and a minor axis (450) or a diameter (460), a stabilizing wheel ridge (330), stabilizing wheel axle support means (322), and stabilizing wheel support (325).

FIG. 7 shows aligned apertures (600) in the second end (344) and in front frame extension (360) and locking pin (610).

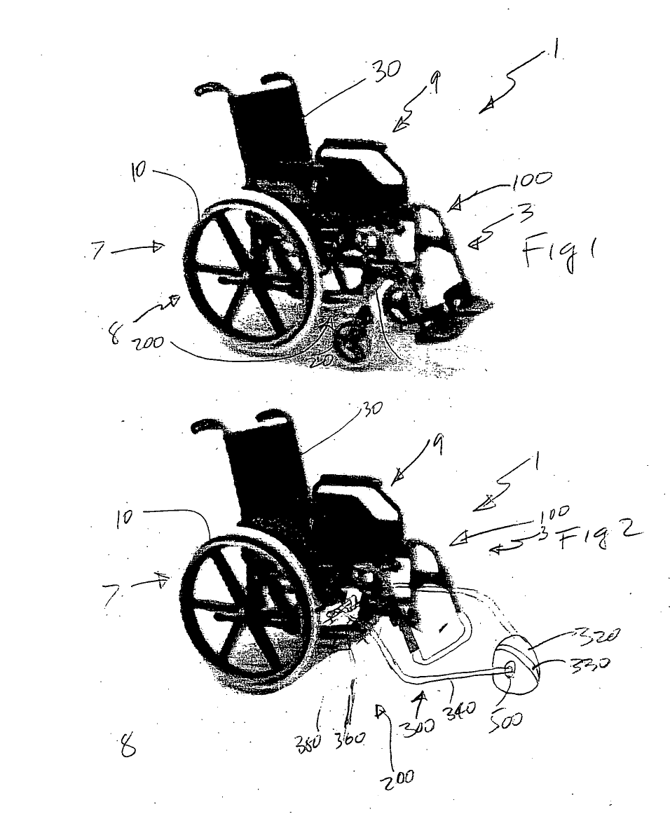

### DETAILED DESCRIPTION OF THE INVENTION

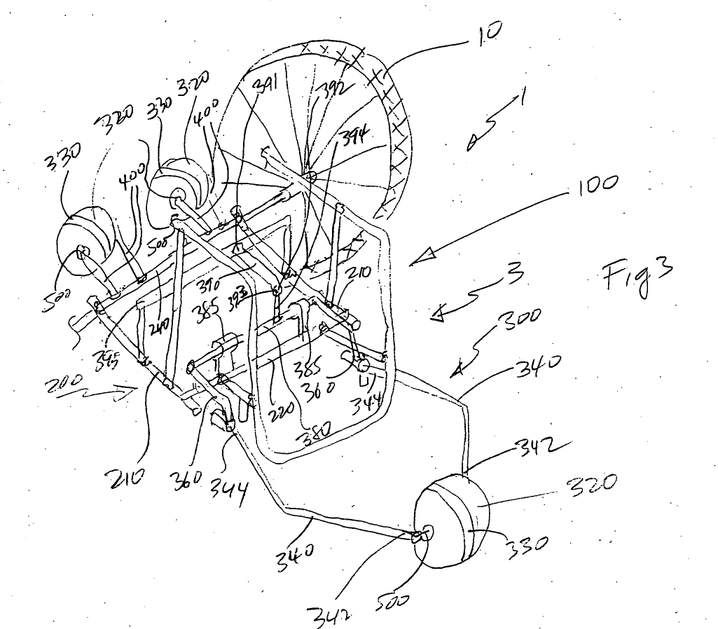

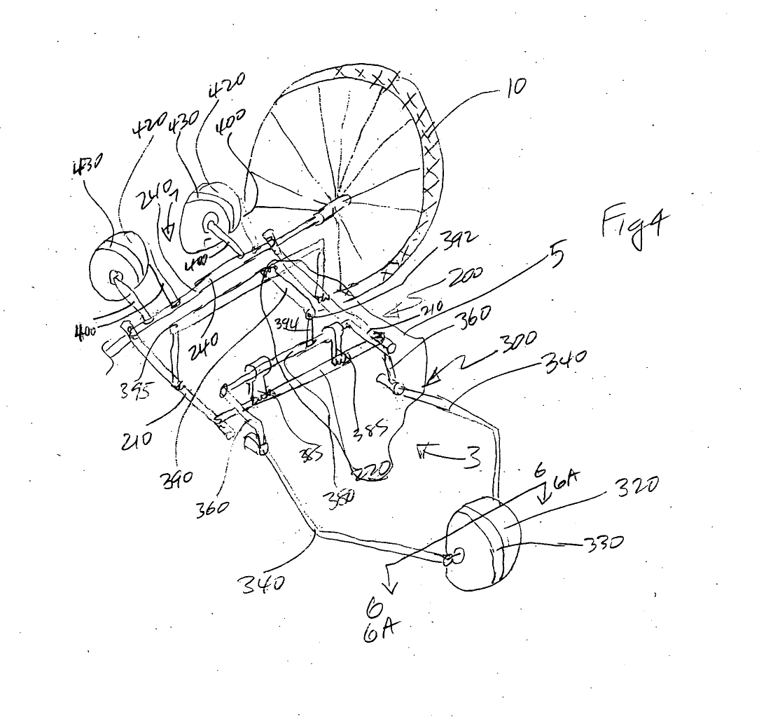

FIGS. 2, 3, 4 and 5 show the stabilizing wheel frame (300) having at least one front stabilizing frame (340); the at least one front stabilizing frame (340) having a first end (342) and a second end (344); a wheel means (320) shown as a stabilizing wheel (320) rotatably received by bearing and axle means (500) at the first end (342); the stabilizing wheel frame (300) is securely and fixedly received by removable means including locking pin (610) and aperture (600). Secure, fixedly and removable means fulfills the function of allowing conversion of the wheelchair (1) from a standard configuration of having front wheels (20) for travel over unobstructed smooth surfaces to the configuration of this invention and, likewise, to allow reconfiguration to the standard front wheels (20) when off-road travel resumes. Those of ordinary skills in mechanical arts will appreciate that in addition to locking pin (610) and aperture (600) that other mechanical means will be available including bolts, screws and quick release mechanisms.

FIGS. 2, 3, 4 and 5 also show the main frame (200) frame means comprised of primary main frame members (210) which are generally of elongated tubular construction of rigid material which are in general alignment with the direction of movement of the wheel chair (1). Other frame construction will fulfill the equivalent structure and serve the equivalent purpose and function. The main frame (200) provides structure to which the invention of this patent discloses. Seen is at least one main frame transverse member (220) which is orthogonal to the direction of travel of the wheelchair (1). However, the orientation of the main frame transverse member (220) is indicated for convenience in facilitating the attachment of the wheel frame (300) so that the front stabilizing frame (340) members project outwardly from the front (3) of the wheelchair (1). The main frame transverse member may have other frame means configurations without bearing on the essence of the invention of this patent.

FIGS. 3, 4 and 5 show the at least one front frame extension (360) which is immovably affixed by frame affixing means to a front frame transverse member (380). Frame affixing means includes welding, bolts, screws, and other permanent affixing means. However, a quick release fixing means may also be employed for the removal of portions of the stabilizing wheel frame (300) when off-road travel is not expected. The stabilizing wheel frame (300) is securely received at the second end (344) by the front frame extension (360) by front frame extension (360) affixing means.

FIGS. 3, 4 and 5 illustrate the at least one transverse pivot (385) which is immovably affixed, by frame affixing means including welding and other mechanical methods, to the at least one main frame transverse member (220); the at least one transverse pivot (385) extends upwardly, via an elongated rigid tubular or solid metal material, presenting a tubular segment which is sized to receive rotatably and bracingly the at least one front frame transverse member (380). The at least one front frame transverse member (380) is rotatably received by the at least one transverse pivot (385). In the preferred embodiment there are at least two transverse pivots (385). The rotation of the at least one frame transverse member (380) is restrained by at least one shock absorber means (390). Shock absorber means is composed of at least one shock absorber (390) with spring, pneumatic and or hydraulic cylinder function. The shock absorber (390) has a shock absorber first end (391) and a shock absorber second end (393); the shock absorber (390) is immovably affixed by shock absorber affixing means at a shock absorber anchor (395); a shock absorber pivot (392) forms the shock absorber second end (393) which is pivotally affixed to a shock absorber front member (394); the shock absorber front member (394) is a linking means and is rigidly affixed to the front frame transverse member (380). Shock absorber (390) affixing means is by bolt or welding. The shock absorber anchor (395) is a tubular transverse member rigidly extending between the primary main frame members (210).

As seen in FIGS. 2, 3, 4, 5 and 6, the at least one front frame extension (360) is tubular and is shaped and sized to receive the second end (344). Tubular affixing means secures the second end (344) at the at least one front frame extension (360).

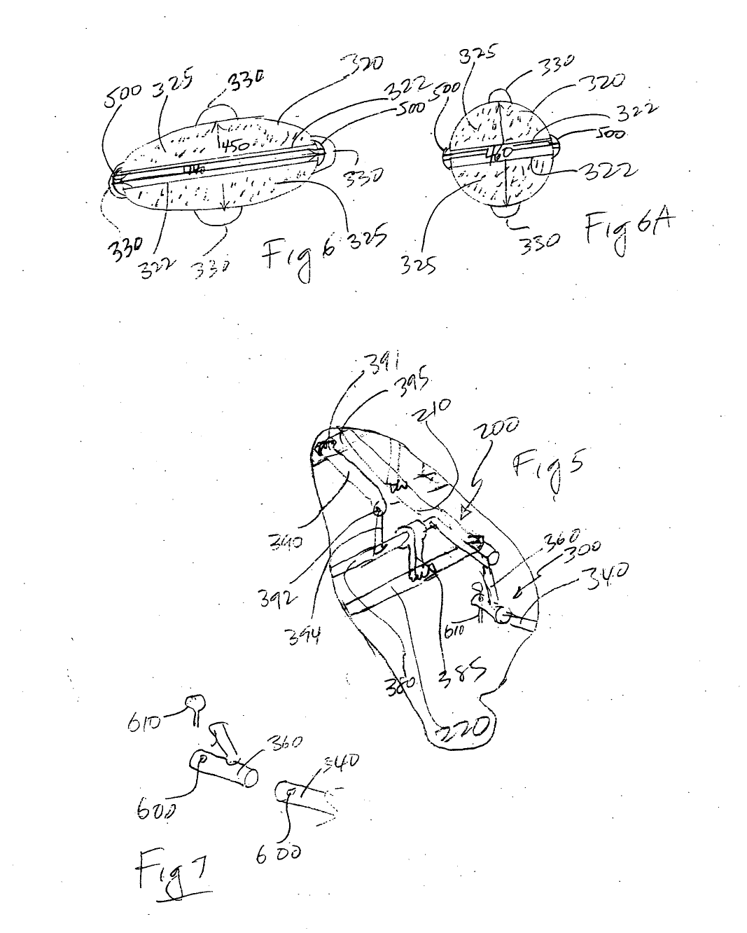

FIGS. 6 and 6A show wheel means (320) which is identified as a stabilizing wheel (320). Wheel means (320) incorporates the elements of a wheel (320), axle and bearings (500), axle support means (322) and wheel support (325). Axle support means (322) is illustrated as a elongated tube which receives an axle. Wheel support (325) includes that content within a generally spheroidal body used for wheel purposes including pressurized gases and plastic or poly foams.

Tubular affixing means, for the preferred embodiment, is composed of aligned apertures (600) in the second end (344) with aligned apertures (600) in the at least one front frame extension (360) where the aligned apertures (600) receive a locking pin (610).

The at least one rear main frame transverse member (240) at the rear (7) is composed of an elongated tube rigidly affixed between the primary main frame members (210) and generally transverse to the direction of travel. An at least one rear stabilizing wheel frame (400) is rigidly affixed to the at least one rear main frame transverse member (240) and extends outwardly from the wheelchair rear (7). The at least one rear stabilizing wheel frame (400) rotatably, bracingly and axle receiving of at least one stabilizing wheel (320). In the preferred embodiment at least two rear stabilizing wheel frames (400) each receive a stabilizing wheel (320).

The at least one front stabilizing frame (340), as seen in FIGS. 2, 3 and 4 in the preferred embodiment, is composed of at least two front stabilizing frames (340) with at least one at the right (8) and one at the left (9). The stabilizing wheel (320) is ellipsoidal, spheroidal, or spherical having a major and minor axis or a diameter; the stabilizing wheel (320) receiving a wheel axle and bearing means (500) at the respective first ends (342) in alignment with the major or minor axis or along a diameter. The stabilizing wheel (320) in the preferred embodiment is spherical and is foam filled thereby giving sufficient structural strength to withstand the forces of the axle and bearings. Axle support means (322) composed of an elongated tube rotatably receiving an axle or of an aperture formed in the Stabilizing wheel (320) and contained stabilizing wheel support (325) of plastic or poly foam. The stabilizing wheel (320) has a stabilizing wheel ridge (330) protruding from the stabilizing wheel (320) at the circumference of the stabilizing wheel (320) equidistant between the respective first ends (342) and orthogonal to the surface of travel. The stabilizing wheel ridge (330) is concave. In the preferred embodiment the stabilizing wheel ridge (330) will be the portion of the stabilizing wheel (320) making contact with the surface which is being transited. The stabilizing wheel ridge (330) composed of a semi rigid plastic or poly material affixed by plastic or poly affixing means, including adhesive and stapling, to the stabilizing wheel (320). In instances where the surface has obstacles, such as pebbles or rocks, the portions of the stabilizing wheel (320) other than the stabilizing wheel ridge (330) will be in contact with surrounding obstacles and will resist stalling of forward motion and in getting stuck in soft earth or sand.

The at least one stabilizing wheel (320) is ellipsoidal, spheroidal, or spherical having a major and minor axis or a diameter. In the preferred embodiment the stabilizing wheel (320) is spherical. At the rear (7) the at least one stabilizing wheel (320) receives a wheel axle and bearing means (500) at the respective at least one rear stabilizing wheel frame (400) in alignment with the major axis (440) or minor axis (450) or along a diameter (460). The at least one stabilizing wheel (420) at the rear (7) has a stabilizing wheel ridge (330) at the perimeter of the at least one stabilizing wheel (320) at the rear (7) along the major axis (440) or minor axis (450) or along a diameter (460) with the stabilizing wheel ridge (330) at the rear (7) being, in the preferred embodiment, orthogonal to the surface of travel and being concave.

What is claimed is:

1. A wheelchair stabilizing wheel frame and stabilizing wheel comprising:
a. a wheelchair (1) having a front (3), a rear (7), a right side (8) and a left side (9) and a main frame (200) composed of frame means;
b. a stabilizing wheel frame (300) having at least one front stabilizing frame (340); the at least one front stabilizing frame (340) having a first end (342) and a second end (344); a stabilizing wheel (320) rotatably received at the first end (342); the stabilizing wheel frame (300) fixedly received by the wheelchair (1) main frame (200) at the second end (344); the stabilizing wheel frame (300) extending outwardly from the wheel chair front (3).

2. A wheelchair stabilizing wheel frame and stabilizing wheel from claim 1 further comprising:
a. main frame (200) frame means comprised of primary main frame members (210) which are of elongated tubular construction of rigid material which are in general alignment with the direction of movement of the wheel chair (1); at least one main frame transverse member (220) is orthogonal to the direction of travel of the wheelchair (1);
b. at least one front frame extension (360) is immovably affixed by frame affixing means to a front frame transverse member (380); the stabilizing wheel frame (300) is securely received at the second end (344) by the front frame extension (360);
c. at least one transverse pivot (385) is immovably affixed to the at least one main frame transverse member (220); the at least one transverse pivot (385) extends upwardly from the at least one main frame transverse member (220); the at least one front frame transverse member (380) is rotatably received by the at least one transverse pivot (385); rotation of the at least one frame transverse member is restrained by at least one shock absorber means.

3. A wheelchair stabilizing wheel frame and stabilizing wheel from claim 2 further comprising:
a. the at least one front frame extension (360) is tubular and is shaped and sized to receive the second end (344); tubular affixing means secures the second end (344) at the at least one front frame extension (360);
b. the at least one transverse pivot (385) is composed of a tube which is circular in cross-section and sized rotatably receive the front frame transverse member (380);
c. at least one shock absorber means is composed of a shock absorber (390) with spring, pneumatic and or hydraulic cylinder function; the at least one shock absorber (390) has a shock absorber first end (391) and a shock absorber second end (393); the shock absorber (390) is immovably affixed by shock absorber affixing means at a shock absorber anchor (395); a shock absorber pivot (392) forms the shock absorber second end (393) which is pivotally affixed to a shock absorber front member (394); the shock absorber front member (394) is a linking means and is rigidly affixed to the front frame transverse member (380).

4. A wheelchair stabilizing wheel frame and stabilizing wheel from claim 3 further comprising:
a. tubular affixing means composed of aligned apertures (600) in the second end (344) with aligned apertures (600) in the at least one front frame extension (360); the aligned apertures (600) receive a locking pin (610); shock absorber affixing means is by bolt or welding; the shock absorber anchor (395) is a tubular transverse member rigidly extending between the primary main frame members (210).

5. A wheelchair stabilizing wheel frame and stabilizing wheel from claim 4 further comprising:
a. at least one rear main frame transverse member (240) at the rear (7) comprised of a elongated tube rigidly affixed between the primary main frame members (210) and generally transverse to the direction of travel; at least one rear stabilizing wheel frame (400) rigidly affixed to the at least one rear main frame transverse member (240) and extending outwardly from the wheelchair rear (7); the at least one rear stabilizing wheel frame (400) rotatably receiving at least one stabilizing wheel (320).

6. A wheelchair stabilizing wheel frame and stabilizing wheel from claim 5 further comprising:
a. the at least one front stabilizing frame (340) composed of at least two front stabilizing frames (340) with at least one at the right (8) and one at the left (9);
b. the stabilizing wheel (320) is ellipsoidal, spheroidal, or spherical having a major and minor axis or a diameter; at the front (3) the stabilizing wheel (320) receiving a wheel axle and bearing means (500) at the respective first ends (342) in alignment with the major or minor axis or along a diameter;
c. the stabilizing wheel (320) has a stabilizing wheel ridge (330) protruding from the stabilizing wheel (320) at the circumference of the stabilizing wheel (320) equidistant between the respective first ends (342) and orthogonal to the surface of travel; the stabilizing wheel ridge (330) is concave;
d. axle support means (322), at the major axis (440) or minor axis (450) or at a diameter (460) rotatably receives and supports an axle; wheel support (325) is the content of a generally spheroidal or ellipsoidal stabilizing wheel (320) including pressurized gases and or plastic or poly foam;
e. the at least one stabilizing wheel (320) at the rear (7) receiving a wheel axle and bearing means (500) at the respective at least one rear stabilizing wheel frame (400) in alignment with the major axis (440) or minor axis (450) or along a diameter (460); the at least one stabilizing wheel (420) at the rear (7) has a stabilizing wheel ridge (330) at the perimeter of the at least one stabilizing wheel (320) at the rear (7) along the major axis (440) or minor axis (450) or along a diameter (460); the stabilizing wheel ridge (330) at the rear (7) is orthogonal to the surface of travel and is concave;
f. the at least one shock absorber (390) composed of at least two shock absorbers (390).

7. A wheelchair stabilizing wheel frame and stabilizing wheel from claim 6 further comprising:
a. axle support means (322) composed of an elongated tube rotatably receiving an axle or of an aperture formed in the Stabilizing wheel (320) and contained stabilizing wheel support (325) of plastic or poly foam;
b. the stabilizing wheel ridge (330) composed of a semi rigid plastic or poly material affixed by plastic or poly affixing means, including adhesive and stapling, to the stabilizing wheel (320).
